(19) United States
(12) Patent Application Publication
(10) Pub. No.: US 2014/0106026 A1
(43) Pub. Date: Apr. 17, 2014

(54) ARTICLE AND METHOD FOR TREATING, PREVENTING AND AMELIORATING ALCOHOL-INDUCED WERNICKE-KORSAKOFF SYNDROME

(71) Applicants: Raphael Wald, Boca Raton, FL (US); Francsico Guerra, Lexington, AL (US)

(72) Inventors: Raphael Wald, Boca Raton, FL (US); Francsico Guerra, Lexington, AL (US)

(21) Appl. No.: 14/055,578

(22) Filed: Oct. 16, 2013

Related U.S. Application Data
(60) Provisional application No. 61/714,410, filed on Oct. 16, 2012.

(51) Int. Cl. C12C 5/02

(52) U.S. Cl. CPC C12C 5/023
USPC 426/2; 426/72

(57) ABSTRACT

The present invention includes a composition and method for treating, preventing and ameliorating alcohol-induced Wernicke-Korsakoff Syndrome using a carrier solution including ingestible ethanol and thiamine.

### INDEX TO RELATED APPLCIATIONS

This application is a non-provisional of and claims benefit to U.S. Provisional Patent Application Ser. No. 61/714,410 filed Oct. 16, 2013 the disclosure of which is incorporated herein by reference in its entirety.

### BACKGROUND OF THE INVENTION

Wernicke-Korsakoff syndrome (also called wet brain, Korsakoff's psychosis, alcoholic encephalopathy, Wernicke's disease, and encephalopathy—alcoholic) is a manifestation of thiamine (vitamin B1) deficiency, or beriberi. This is usually secondary to alcohol abuse. It mainly causes vision changes, ataxia and impaired memory.

Wernicke-Korsakoff syndrome is usually found in chronic alcoholics. Wernicke-Korsakoff syndrome results from thiamine deficiency. It is generally agreed that Wernicke's encephalopathy results from severe acute deficiency of thiamine (vitamin B1), whilst Korsakoff's psychosis is a chronic neurologic sequela after Wernicke's encephalopathy. The metabolically active form of thiamine is thiamine diphosphate which plays a major role as a cofactor or coenzyme in glucose metabolism. The enzymes which are dependent on thiamine diphosphate are associated with the citric acid cycle (also known as the Krebs cycle), and catalyze the oxidation of pyruvate, alphaketoglutarate and branched chain amino acids. Thus, anything that encourages glucose metabolism will exacerbate an existing clinical or sub-clinical thiamine deficiency.

The human body does not produce thiamine, but rather takes it in through diet or supplementation. Thiamine serves to break down carbohydrates and is crucial for the production of molecules which are vital for brain functioning. Thiamine deficiency negatively impacts several organs in the body including the brain, liver, and heart. Thiamine supplementation has been shown to improve cognitive functioning even in those with adequate thiamine status. Thiamine supplementation is commonly used intravenously and intramuscularly in order to alleviate symptoms of Wernicke-Korsakoff Syndrome.

A significant problem arises in that; alcoholics are not prone to being compliant patients for therapeutic regimen. There exists a need to provide therapy in a manner in which it will be effectively applied

### SUMMARY OF THE INVENTION

The present invention provides for administration of Thiamine

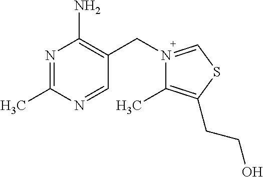

Thiamine is 2-[3-[(4-Amino-2-methyl-pyrimidin-5-yl)methyl]-4-methyl-thiazol-5-yl] ethanol, also known as Vitamin B1. Thiamine is soluble in water, methanol, and glycerol and practically insoluble in acetone, ether, chloroform, and benzene. It is stable at acidic pH, but is unstable in alkaline solutions. Thiamine is released by the action of phosphatase and pyrophosphatase in the upper small intestine. At low concentrations, the process is carrier-mediated, and, at higher concentrations, absorption occurs via passive diffusion. Active transport is greatest in the jejunum and ileum (it is inhibited by alcohol consumption and by folic deficiency). Decline in thiamine absorption occurs at intakes above 5 mg.

The present invention contemplates providing alcohol products enriched with added thiamine in order to effectively deliver thiamine to those who consume alcohol.

### DETAILED DESCRIPTION OF THE PREFERRED EMBODIMENT

A thiamine dose in combination with alcohol according to the present invention is between about 2 mg and 15 mg per oz. of alcohol regardless of type of alcohol (beer, liquor etc.).

In a preferred embodiment, the dose is between about 2-5 mg per oz. of alcohol.

Wine and cordials contain significant amounts of sulfite, which degrades thiamine and present special formulation concerns. Beer, liquor, and other forms of alcohol have only negligible amounts of sulfite and thus would not significantly affect thiamine through degradation.

If wine and cordials are desired, the present invention provides a formulation of enteric-coated microspheres targeted for colonic delivery. Colonic delivery is preferred because the pH is slightly acidic, generally accepted to be about 6.8, and will allow absorption of thiamine without significant degradation.

Although wine and cordials would require use of encapsulated-enteric coated thiamine, the present invention contemplates that encapsulated thiamine being used in all alcohols and not being limited only to wine and cordials.

Thiamine has a half-life, in vivo, of approximately two weeks. Subsequently, it would still be present in the system long after the alcohol had been excreted making the length of time in the system a non-issue.

The method of the present invention includes: selecting an alcoholic beverage; determining common consumption volume of said beverage; adding thiamine to said beverage, wherein said adding results in a final composition having 2-15 mg per oz w/v.

This method, in one embodiment, includes steps of evaluating they type of alcohol consumed, determining the alcohol content by volume of the alcohol consumed, adding between about 2-15 mg of thiamine per ounce of alcohol, whereby ounce of alcohol is based on the alcohol content. As one, non-limiting example, an eighty proof whisky is about forty percent alcohol by volume. A 32 oz. bottle contains approximately 12.8 oz. of alcohol. Thiamine can be added to the bottle in the range of 25.6-192 mg according to the present invention. This is but one example as the thiamine is adjustable to deliver a desired amount of thiamine based on the alcoholic carrier being used.

While to some, the concept of adding thiamine to alcohol might be objectionable based on taste; it is known in the art that, at least in beer and hard alcohol, the taste is statistically imperceptible. Additionally, in providing a microencapsulated thiamine in alcohol there would be a minimal chance of any taste perception.

As discussed above, if microencapsulated thiamine is used, the pH of the drink would prevent release of the thiamin. The pH of beer is typically 3.5-4.2. The pH of wine is typically between about 2.9-3.9. Other hard alcohols generally are between about 3.5-5.5. Thus, known methods of enteric encapsulation whereby a delayed release is controlled until either a pH of 6.8 (small intestines) or 7.5 (large intestines) would ensure the thiamine is not released in the drink, yet is still released in the alimentary canal, thus providing the desired administration to a person drinking the alcohol.

The amount is adjustable dependent on beverage used. Beer drinkers consume greater volume of alcohol than those who consume whiskey or other alcohols having higher alcohol content.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A composition for treating, preventing and ameliorating alcohol-induced Wernicke-Korsakoff Syndrome, said composition comprising:
a carrier solution including ingestible ethanol; and thiamine.

2. The composition of claim 1, wherein said carrier solution is beer.

3. The composition of claim 1, wherein said carrier solution is an alcoholic drink having an alcohol content between about 3.5-80%.

4. The composition of claim 1, wherein said thiamine is added in an amount of about 2-15 mg/oz of carrier w/v.

5. The composition of claim 1, wherein said thiamine is added in an amount of about 2-5 mg/oz of carrier w/v.

6. The composition of claim 1 wherein said thiamine is microencapsulated.

7. The composition of claim 1 wherein said thiamine is microencapsulated with a controlled release coating.

8. The composition of claim 1 wherein said thiamine is microencapsulated with a controlled release coating for release in an environment at pH 6.8.

9. The composition of claim 1 wherein said thiamine is microencapsulated with a controlled release coating for release in an environment at pH 7.5.

10. The composition of claim 1, wherein said thiamine is added in an amount of about 0.06-1.0 mg/oz of alcohol in said carrier.

11. A method of for treating, preventing and ameliorating alcohol-induced Wernicke-Korsakoff Syndrome comprising:
providing a composition according to claim 1;
ingesting said composition.

12. The method of claim 11 further including the step of microencapsulting said thiamine prior to combining with said carrier.

13. The method of claim 11 further including the step of microencapsulting said thiamine prior to combining with said carrier, wherein said microencapsulation includes utlization of at least one controlled release material.

14. The method of claim 13 wherein said controlled release material provides a delayed release at pH 6.8.

15. The method of claim 13 wherein said controlled release material provides a delayed release at pH 7.5.

16. The method of claim 11 furtehr comprising the step of calculating the alcohol content of said carrier and adding an amount of thiamine between about 0.1 mg-6 mg w/v per ounce of alcohol in said carrier.
